(19) United States
(12) Patent Application Publication
(10) Pub. No.: US 2008/0027731 A1
(43) Pub. Date: Jan. 31, 2008

(54) Comprehensive Spoken Language Learning System

(75) Inventor: Zeev Shpiro, Ra'anana (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Burlington English Ltd., Gibralter (GI)

(21) Appl. No.: 10/599,902

(22) PCT Filed: Apr. 12, 2005
(86) PCT No.: PCT/US05/12497

§ 371 Date: Aug. 29, 2007

Related U.S. Application Data
(60) Provisional application No. 60/562,084, filed on Apr. 12, 2004.

(51) Int. Cl. G10L 21/06

(52) U.S. Cl. 704/276; 704/E11.001

(57) ABSTRACT

A computerized method of teaching spoken language skills includes receiving multiple user utterances into a computer system, receiving criteria for pronunciation errors, analyzing the user utterances to detect pronunciation errors according to basic sound units and Pronunciation error criteria, and providing feedback to the user in accordance with the analysis.

### TECHNICAL FIELD

This invention relates generally to educational systems and, more particularly, to computer-assisted spoken language instruction.

### BACKGROUND ART

Many applications have been developed targeting teaching spoken language skills using a computer such as a PC. Some applications were very ambitious, and attempted to replace a teacher in a classroom or a private lesson, whereas some applications were more modest, and only targeted providing additional training and practice that could not otherwise be achieved without presence of a native speaker as a teacher. For example, a native English Speaker is a rare and expensive resource in most places in the world that are not themselves populated with native English Speakers. Therefore there is a continuous effort to increase the efficiency of properly utilizing computerized systems to support foreign language teaching and especially the spoken language skills of that language.

Many language instruction inventions can also be found in the field, but most of them are still lacking the proper definition and set of features that will make them a popular means to acquire spoken language skills.

It is known to provide a system that includes identification of pronunciation errors, where such criteria is more suitable to a phonetician, whereas an average teacher has requirements for a student of a foreign language (such as English) that are typically much lower.

Teachers, in general, encourage students who want to acquire the spoken language skills to speak first. Immediate correction on multiple errors can discourage the student, rather than encourage him/her in their study.

To provide improved instruction, two application engines can be defined: Pronunciation and Communication. Both engines can be based on the same Speech Recognition engine optimized to identify pronunciation errors. But the difference between them is typically the set of rules that are being used to identify pronunciation errors and the criteria defining the errors to be reported to the user and those that should be ignored and skipped.

### SUMMARY

The present invention supports interactive dialogue in which a spoken user input is recorded into a computerized device and then analyzed according to phonetic criteria. A computerized method of teaching spoken language skills includes receiving multiple user utterances into a computer system, receiving criteria for pronunciation errors, analyzing the user utterances to detect pronunciation errors according to basic sound units and Pronunciation error criteria, and providing feedback to the user in accordance with the analysis.

In communication mode of the application software, the system is generally more tolerant to pronunciation errors and can provide feedback, for example, only on those errors that cause the user to be misunderstood. Any other pronunciation error may be skipped. The described system can be generalized by defining additional two filters to the “ultimate” speech recognition engine targeting identifying pronunciation errors, in order to comply with the different application requirements.

In a pronunciation mode, all pronunciation errors are the targets of the Speech Recognition error engine, whereas in a communication mode, some of the errors are enabled (i.e. skipped) by the engine, some are identified but not presented as feedback to the user, and some are identified and presented as feedback to the user.

It may be considered not to include the rules in the first engine at all, and therefore such a system can eliminate the need for the first filter. Unfortunately, it is equivalent to operating speech recognition of Native language speakers on non-native and this set up typically does not achieve the desired performance. When the set of rules and/or models is enlarged, some mistakes that according to teachers are not critical will not be reported as errors at the analysis phase. Then, when an error is identified, the application in communication mode may still not indicate the error to the user following the criteria that were set up.

Other features and advantages of the present invention should be apparent from the following description of the preferred embodiment, which illustrates, by way of example, the principles of the invention.

### BRIEF DESCRIPTION OF DRAWINGS

FIG. 1 shows a user making use of a language training system constructed according to the present invention.

FIG. 2 shows a display screen of the FIG. 1 system prompting a user to speak several words.

FIG. 3 shows a display screen of the FIG. 1 system, after all words were recorded by the user, offering analysis of user pronunciation errors (adding Analyze button at the center bottom of the screen).

FIG. 4 shows the display screen of the FIG. 1 system providing pronunciation error analysis of the words recorded as in FIG. 3.

FIG. 5 shows the display screen of the FIG. 1 system prompting a user to speak several expressions.

FIG. 6 shows the display screen of the FIG. 1 system providing pronunciation error analysis of the expressions recorded as in FIG. 5.

FIG. 7 shows a display screen of an exercise training a user with the proper language required for dialogue.

FIG. 8 shows a display screen of Mini Dialogue after the user has recorded all the responses and they were analyzed in accordance with communication criteria, thus providing overall speech grade and pronunciation Help.

FIG. 9 shows a display screen of a Dialogue conducted between the user and the system/PC. The user is selecting to play Speaker A or B roll. Then he/she is triggered to record the speaker roll in response to the PC “speaking” the other speaker roll.

FIG. 10 shows a display screen of the FIG. 1 system providing communication performance result and offering pronunciation error analysis of the dialogue recorded according to the application described in FIG. 9.

### DETAILED DESCRIPTION

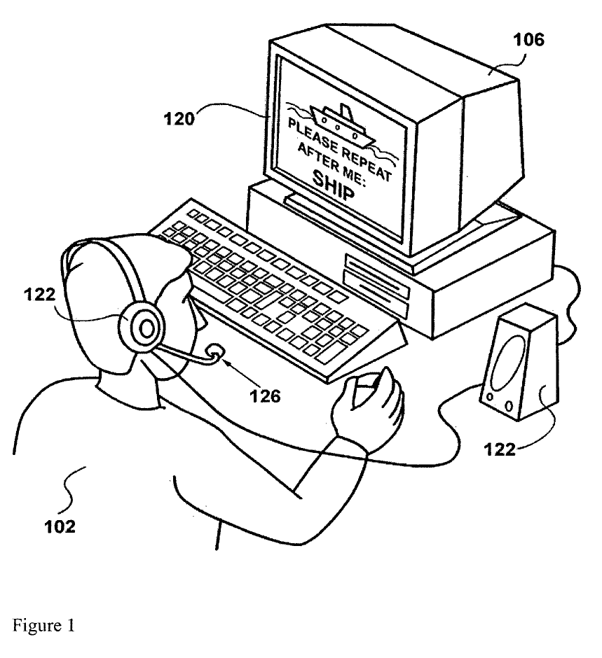

FIG. 1 is a representation of a user 102 using the Spoken Language System constructed according to the current invention. The system shown in FIG. 1 includes a PC 106 with a Sound Card, speakers or headset 122, and a microphone 126. The PC plays multiple roles in the system. Its CPU runs the application, its display 120 presents the application screens, and its audio interface plays the application prompts through the speakers or headset 122. In addition, the PC Audio input is being used to record (via the microphone 126) the user produced utterances. These utterances are recorded to the PC memory to be later played back to the user and/or analyzed according to pronunciation or communication analysis criteria.

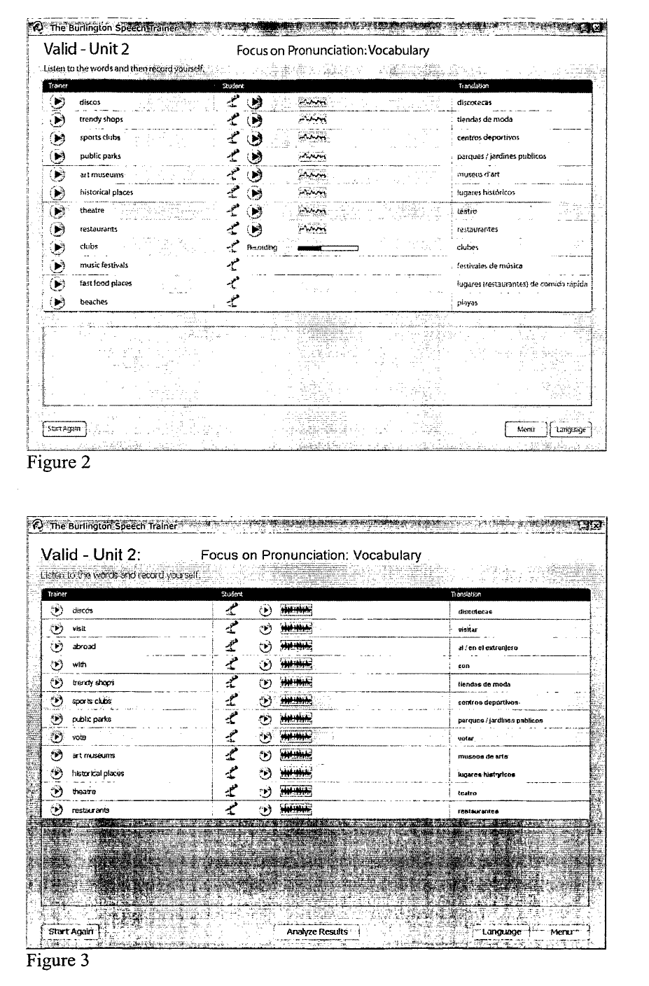

FIG. 2 shows a visual display of the screen 120 that prompts or triggers the user to speak multiple words. In the current application software, the user first produces (speaks) all the words. Each word is displayed on the screen and the user can listen to it being spoken by clicking on the play button located on the left side of each word. The user clicks on the microphone button and then records the user's pronunciation of the word. During recording, a record level indicator is displayed in the recorded word row. If recording is rejected because the speech was too soft, too loud etc., an error message is immediately displayed on the pronounced word row. If the word was properly recorded (regardless of pronunciation errors), a signal symbol is presented on the display and a user play button is added on the right side of the microphone display icon. The Student Play button enables the user to play his/her recorded word. Each word translation is also displayed on the right side of the word row. The user has to finish recording all the prompted words in order to continue with the application. The words can be recorded in any order as long as, at the end, all the prompted words are recorded. The user may also, after listening to his/her recordings, elect to re-record a certain word. The user can do so, and the last recording of each word is taken into account for the following parts of the application.

FIG. 3 shows a visual display of the screen described in FIG. 2 above, after all words were successfully recorded. Some words may have been recorded several times, but there is no external indication to the number of times each word was recorded. Only the last recording will be analyzed in the following part of the application software. After all words are recorded, a new button is presented at the center bottom of the display—shown in FIG. 3 as “Analyze Results”. This button enables the user to run the application software analysis program, and analyze user recordings of the presented words to find pronunciation errors.

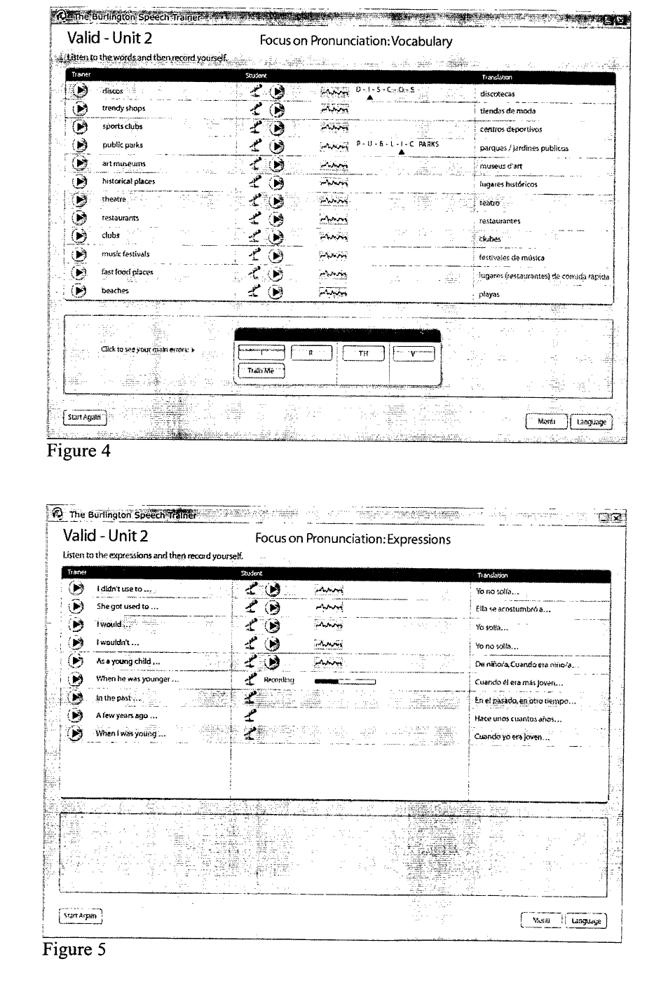

FIG. 4 shows a visual display of a feedback of pronunciation error analysis performed on the words presented in FIG. 3 above, after the user had clicked on the Analyze Results display button. Up to five pronunciation errors are displayed in the pronunciation feedback window. Each pronunciation error is identified by English letters (e.g. IH) symbolizing the phoneme that was not pronounced properly, and/or another text that provides the user indication on the error phoneme (e.g. sheep). This kind of simplified text may be required, since most users of such systems are not familiar with the phonetic alphabet. When one of these error phoneme buttons is clicked, the system displays all words where the error was found, and indicates the exact location of the error within the word. This is done by displaying the “spelling” of the word, and adding a red triangle below the part of the text that represents the phoneme that was identified as pronounced incorrectly. The user is also offered additional training and practice for the specific sound that was mispronounced. By clicking on the “Train Me” button shown in FIG. 4, that appears below the mispronounced phoneme, the user is being introduced to another part of the application that teaches and practices the student how to properly produce the sound.

FIG. 5 shows a visual display of a similar screen as in FIG. 2, which triggers the user to speak. In FIG. 2, the recorded utterances were words, whereas in FIG. 5 these are expressions composed of multiple words. The application is also similar to the one described in FIG. 2 above, that encourages the user to record all expressions before offering Pronunciation analysis.

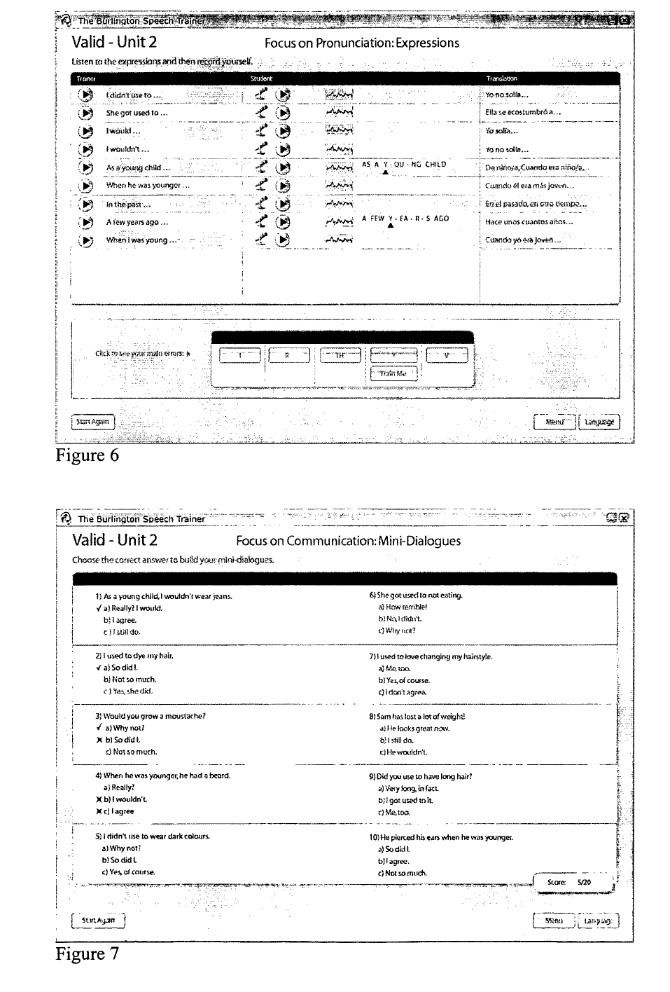

FIG. 6 shows the computer system display screen providing feedback on the user's production of the inputted expressions. As in FIG. 4 above, where analysis results are displayed for words, the FIG. 5 screen provides feedback on the analysis results for the recorded expressions. Up to five phonemes that were mispronounced are displayed. When a user selects any of them, the application presents the expressions and exact location within each of the expressions where this error was identified. The user may also click on the newly appeared button—“Train Me”—that will offer additional teaching, training, and exercises on the proper production of the mispronounced sound (phoneme).

FIG. 7 shows a visual display of the system teaching the user the correct language required to conduct a dialogue. There are multiple questions and multiple answers for each of them. The user is requested to select the appropriate answer to each statement in the question. This exercise trains the user in dialogue language prior to the oral dialogue that follows this part of the application. A score is given to the overall student performance in this exercise.

FIG. 8 shows a display screen of the computer system that practices the user in dialogues. This part of the application software is called “Mini Dialogue” since the system/PC represents one of two speakers, where the user is the other one. These are short dialogues, one phrase for each speaker. The system prompts the user and he/she is requested to orally complete the other speaker role in the dialogue. After all recordings have been completed, the system analyzes the user utterances and provides a grade on the user overall speech performance as well as providing pronunciation help. The Speech Recognition engine being used in this application is the communication one, where only a subset of the pronunciation rules are active and the system emphasizes more on the communication skills than on the pronunciation skills.

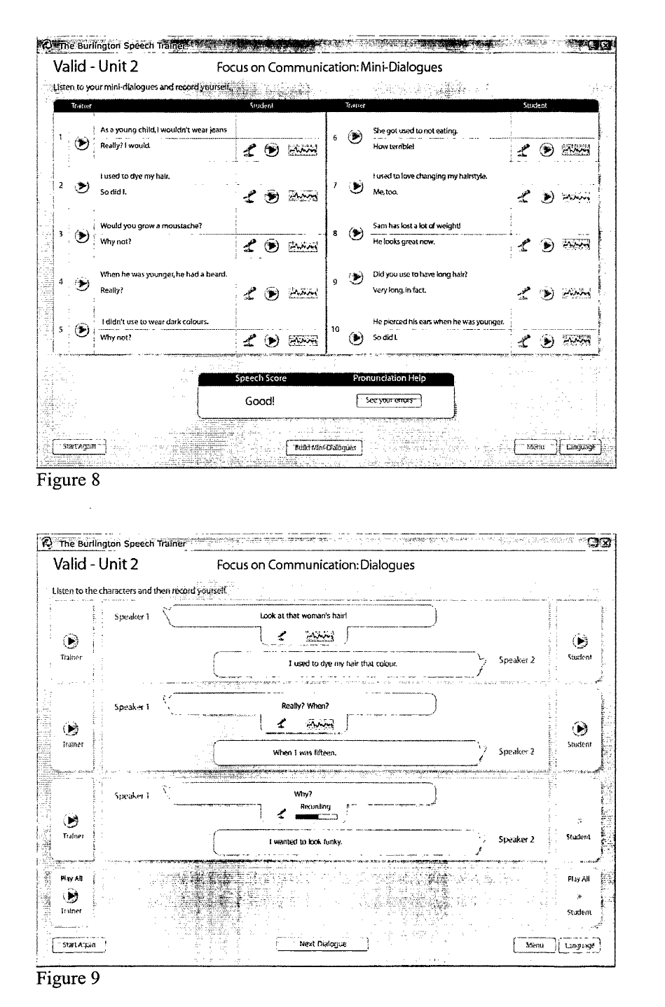

FIG. 9 shows a display screen of the computer system that practices a more complete dialogue (compared to the Mini Dialogues presented in FIG. 8 above). In this case the user selects to be either speaker A or speaker B and then orally interacts with the PC that plays the other speaker role. The exercise goal is to improve and practice the user fluency in spiking the language while conducting a dialogue. Unless the user makes a “significant” mistake, the system will not comment and let the user record his/her part of the dialogue without interference.

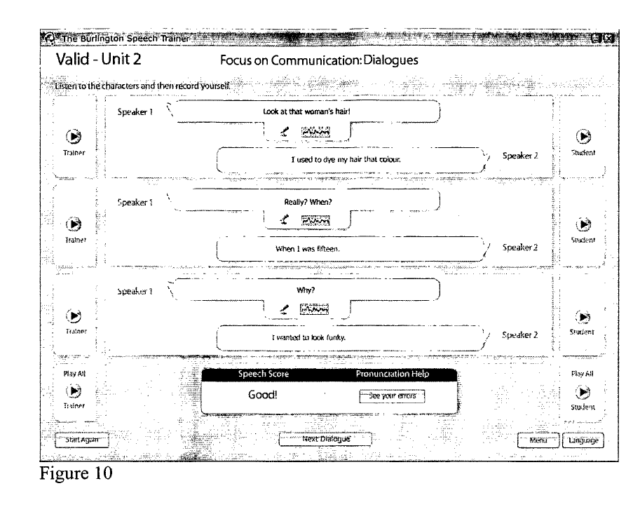

FIG. 10 shows a display screen of the computer system that practices dialogues as presented in FIG. 9 above, where all user utterances were successfully recorded and are analyzed for fluency, intelligibility and pronunciation errors. The speech score is immediately presented, where in order to receive the pronunciation feedback the user should click on the Pronunciation Help button (“See your errors”), and then the pronunciation errors are presented (in a similar way as for the words and expressions). This part of the application uses the Communication Engine, which is the same Speech Recognition Engine that operates with sub set of the Pronunciation Errors rules, and thus enables (skips) certain pronunciation errors that are not effecting the intelligibility of the utterance, and indicate others that are unacceptable by an average teacher in a classroom.

I claim:

1. A computerized method of teaching spoken language skills comprising:
a. Receiving multiple user utterances into a computer system;
b. Receiving criteria for pronunciation errors;
c. Analyzing the user utterances to detect pronunciation errors according to basic sound units and Pronunciation error criteria;
d. Providing feedback to the user in accordance with the analysis.

2. The method of claim 1, wherein analyzing includes garbage analysis that determines if the user utterance is a grossly different utterance than the desired utterance.

3. The method of claim 1, wherein analyzing includes identification of pronunciation error.

4. The method of claim 1, wherein the pronunciation error analysis criteria determines if method target is communication or pronunciation.

5. The method of claim 1, wherein pronunciation error analysis criteria indicates the errors that are reported to the user.

6. A computerized system for teaching spoken language skills to a user, the system comprising a computer processor that produces application prompts for an audio playback interface, receives multiple user utterances from an audio input device, receives criteria for pronunciation errors, analyzes the user utterances to detect pronunciation errors according to basic sound units and pronunciation error criteria, and provides feedback to the user on a visual display that shows application screens produced by the computer processor in accordance with the analysis.

7. The computerized system of claim 6, wherein the computer processor further performs a garbage analysis that determines if the user utterance is a grossly different utterance than the desired utterance.

8. The computerized system of claim 6, wherein the computer processor further performs identification of pronunciation error.

9. The computerized system of claim 6, wherein the pronunciation error analysis criteria determines if method target is communication or pronunciation.

10. The computerized system of claim 6, wherein pronunciation error analysis criteria indicates the errors that are reported to the user.
